(19) United States
(12) Patent Application Publication
(10) Pub. No.: US 2018/0038400 A1
(43) Pub. Date: Feb. 8, 2018

(54) COUPLING SYSTEM

(71) Applicant: GM GLOBAL TECHNOLOGY OPERATIONS LLC, DETROIT, MI (US)

(72) Inventors: Alan L. Browne, Grosse Pointe, MI (US); Nancy L. Johnson, Northville, MI (US); Nilesh D. Mankame, Ann Arbor, MI (US)

(21) Appl. No.: 15/230,630

(22) Filed: Aug. 8, 2016

(51) Int. Cl. F16B 5/06; B29C 65/56; B29C 61/06

(52) U.S. Cl. CPC F16B 5/0657; B29C 61/0608; B29C 65/565; B29K 2995/0046; B29L 2031/7278

(57) ABSTRACT

A coupling assembly includes first and second components with mating protrusions including shape memory polymer protrusions with different shape configurations. The components are assembled by engaging the protrusions with a temporary shape configuration at a first level of retention force. The protrusions are heated above the transition temperature to recover a permanent shape configuration, and cooled to provide a second level of retention force at the permanent shape configuration.

### FIELD OF THE INVENTION

The subject invention relates to matable components and, more specifically, to deformable matable components such as can be used in vehicles.

### BACKGROUND

Components, in particular vehicular components such as used in automotive vehicles, can be coupled to each other with one or more fasteners such as screws or nuts and bolts. However, the use of fastener systems results in increased parts, increased cost, increased assembly time, and may lead to relative motion between the components and fasteners, which can cause misalignment between components and undesirable noise such as squeaking and rattling.

### SUMMARY OF THE INVENTION

In some embodiments, a method is provided for manufacturing an assembly. The assembly comprises a first component comprising a plurality of engaging protrusions and a second component comprising a plurality of receiving protrusions that comprise a shape memory polymer in a first shape configuration. The method comprises assembling the first and second components, engaging the engaging protrusions with the receiving protrusions at a first level of retention force between the engaging protrusions and the receiving protrusions. The receiving protrusions are heated above the transition temperature to recover a second shape configuration, and cooled below the transition temperature to retain the second shape configuration and provide a second level of retention force between the engaging protrusions and the receiving protrusions. In some embodiments, the second level of retention force is greater than the first level of retention force. This configuration can allow for easy assembly of components at the first level of retention force, with the higher second level of retention force helping to maintain the assembly in its assembled state. In some embodiments, the second level of retention force is lower than the first level of retention force. In some embodiments, this configuration can allow for easy dis-assembly of mated components such as during end-of-life recycling.

In some embodiments, a coupling system comprises a first component comprising a plurality of engaging protrusions and a second component comprising a plurality of receiving protrusions configured for engagement with the first component engaging protrusions. The receiving protrusions comprise a shape memory polymer configured in a first shape configuration, with a second recoverable stored shape configuration. The engaging protrusions and receiving protrusions are configured to engage at a first level of retention force with the receiving protrusions configured in the first shape configuration, and at a second level of retention force with the receiving protrusions configured in the second shape configuration

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic depiction of a perspective view of an example of a first component with engaging protrusions as described herein;

FIG. 2 is a schematic depiction of a perspective view of an example of a second component with receiving protrusions as described herein;

FIG. 3 is a schematic perspective view of an assembly for a vehicle, wherein the assembly includes an energy storage device manufactured from a plurality of members.

FIG. 4 is a schematic plan view of a first face of one of the members of the energy storage device shown in FIG. 3.

FIG. 5 is a schematic plan view of a second face of one of the members of the energy storage device shown in FIG. 3.

FIG. 6 is a schematic depiction of a plan view of the second component of FIG. 2 also depicting the location of engaging protrusions from the first component engaged with the receiving protrusions of the second component;

FIG. 7 is a schematic depiction of a perspective view of a portion of the second component of FIG. 2, depicting the receiving protrusions in two shape configurations; and

FIG. 8 is a schematic depiction of a plan view of the first component of FIG. 1, depicting the engaging protrusions of in two shape configurations.

### DETAILED DESCRIPTION

The following description is merely exemplary in nature and is not intended to limit the present disclosure, its application or uses. For example, the embodiments shown are applicable to vehicle components, but the system disclosed herein may be used with any suitable components to provide securement and retention of mating components and component applications, including many industrial, consumer product (e.g., consumer electronics, various appliances and the like), transportation, energy and aerospace applications, and particularly including many other types of vehicular components and applications, such as various interior, exterior, electrical and under-hood vehicular components and applications. It should be understood that throughout the drawings, corresponding reference numerals indicate like or corresponding parts and features.

As mentioned above, components can comprise protrusions comprising a shape memory polymer. “Shape memory polymer” or “SMP” generally refers to a polymeric material, which exhibits a change in a property, such as an elastic modulus, a shape, a dimension, a shape orientation, or a combination comprising at least one of the foregoing properties upon application of an activation signal. Shape memory polymers may be thermoresponsive (i.e., the change in the property is caused by a thermal activation signal), photoresponsive (i.e., the change in the property is caused by a light-based activation signal), moisture-responsive (i.e., the change in the property is caused by a liquid activation signal such as humidity, water vapor, or water), or a combination comprising at least one of the foregoing.

Generally, SMPs are phase segregated co-polymers comprising at least two different units, which may be described as defining different segments within the SMP, each segment contributing differently to the overall properties of the SMP. As used herein, the term “segment” refers to a block, graft, or sequence of the same or similar monomer or oligomer units, which are copolymerized to form the SMP. Each segment may be crystalline or amorphous and will have a corresponding melting point or glass transition temperature (Tg), respectively. The term “thermal transition temperature” is used herein for convenience to generically refer to either a Tg or a melting point depending on whether the segment is an amorphous segment or a crystalline segment. For SMPs comprising (n) segments, the SMP is said to have a hard segment and (n−1) soft segments, wherein the hard segment has a higher thermal transition temperature than any soft segment. Thus, the SMP has (n) thermal transition temperatures. The thermal transition temperature of the hard segment is termed the “last transition temperature”, and the lowest thermal transition temperature of the so-called “softest” segment is termed the “first transition temperature”. It is important to note that if the SMP has multiple segments characterized by the same thermal transition temperature, which is also the last transition temperature, then the SMP is said to have multiple hard segments.

When the SMP is heated above the last transition temperature, the SMP material can be imparted a permanent shape. A permanent shape for the SMP can be set or memorized by subsequently cooling the SMP below that temperature. As used herein, the terms “original shape”, “previously defined shape”, and “permanent shape” are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment while maintaining the deforming external stress or load.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it may be possible to demonstrate multiple permanent shapes. Similarly using a layered or composite approach, a combination of multiple SMPs will demonstrate transitions between multiple temporary and permanent shapes.

For SMPs with only two segments, the temporary shape of the shape memory polymer is set at the first transition temperature, followed by cooling of the SMP, while under load, to lock in the temporary shape. The temporary shape is maintained as long as the SMP remains below the first transition temperature. The permanent shape is regained when the SMP is once again brought above the first transition temperature with the load removed. Repeating the heating, shaping, and cooling steps can repeatedly reset the temporary shape.

Most SMPs exhibit a “one-way” effect, wherein the SMP exhibits one permanent shape. Upon heating the shape memory polymer above a soft segment thermal transition temperature without a stress or load, the permanent shape is achieved and the shape will not revert back to the temporary shape without the use of outside forces.

As an alternative, some shape memory polymer compositions can be prepared to exhibit a “two-way” effect, wherein the SMP exhibits two permanent shapes. These systems include at least two polymer components. For example, one component could be a first cross-linked polymer while the other component is a different cross-linked polymer. The components are combined by layer techniques, or are interpenetrating networks, wherein the two polymer components are cross-linked but not to each other. By changing the temperature, the shape memory polymer changes its shape in the direction of a first permanent shape or a second permanent shape. Each of the permanent shapes belongs to one component of the SMP. The temperature dependence of the overall shape is caused by the fact that the mechanical properties of one component (“component A”) are almost independent of the temperature in the temperature interval of interest. The mechanical properties of the other component (“component B”) are temperature dependent in the temperature interval of interest. In one embodiment, component B becomes stronger at low temperatures compared to component A, while component A is stronger at high temperatures and determines the actual shape. A two-way memory device can be prepared by setting the permanent shape of component A (“first permanent shape”), deforming the device into the permanent shape of component B (“second permanent shape”), and fixing the permanent shape of component B while applying a stress.

It should be recognized by one of ordinary skill in the art that it is possible to configure SMPs in many different forms and shapes. Engineering the composition and structure of the polymer itself can allow for the choice of a particular temperature for a desired application. For example, depending on the particular application, the last transition temperature may be about 0° C. to about 300° C. or above. A temperature for shape recovery (i.e., a soft segment thermal transition temperature) may be greater than or equal to about −30° C. Another temperature for shape recovery may be greater than or equal to about 40° C. Another temperature for shape recovery may be greater than or equal to about 100° C. Another temperature for shape recovery may be less than or equal to about 250° C. Yet another temperature for shape recovery may be less than or equal to about 200° C. Finally, another temperature for shape recovery may be less than or equal to about 150° C.

Optionally, the SMP can be selected to provide stress-induced yielding, which may be used directly (i.e. without heating the SMP above its thermal transition temperature to ‘soften’ it) to make the SMP conform to a given surface. The maximum strain that the SMP can withstand in this case can, in some embodiments, be comparable to the case when the SMP is deformed above its thermal transition temperature.

Suitable shape memory polymers, regardless of the particular type of SMP, can be thermoplastics, thermosets-thermoplastic copolymers, interpenetrating networks, semi-interpenetrating networks, or mixed networks. The SMP “units” or “segments” can be a single polymer or a blend of polymers. The polymers can be linear or branched elastomers with side chains or dendritic structural elements. Suitable polymer components to form a shape memory polymer include, but are not limited to, polyphosphazenes, poly(vinyl alcohols), polyamides, polyimides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecylacrylate). Examples of other suitable polymers include polystyrene, polypropylene, polyvinyl phenol, polyvinylpyrrolidone, chlorinated polybutylene, poly(octadecyl vinyl ether), poly (ethylene vinyl acetate), polyethylene, poly(ethylene oxide)-poly(ethylene terephthalate), polyethylene/nylon (graft copolymer), polycaprolactones-polyamide (block copolymer), poly(caprolactone) dimethacrylate-n-butyl acrylate, poly(norbornyl-polyhedral oligomeric silsequioxane), polyvinylchloride, urethane/butadiene copolymers, polyurethane-containing block copolymers, styrene-butadiene block copolymers, and the like. The polymer(s) used to form the various segments in the SMPs described above are either commercially available or can be synthesized using routine chemistry. Those of skill in the art can readily prepare the polymers using known chemistry and processing techniques without undue experimentation.

As will be appreciated by those skilled in the art, conducting polymerization of different segments using a blowing agent can form a shape memory polymer foam, for example, as may be desired for some applications. The blowing agent can be of the decomposition type (generates a gas upon chemical decomposition) or an evaporation type (which vaporizes without chemical reaction). Exemplary blowing agents of the decomposition type include, but are not intended to be limited to, sodium bicarbonate, azide compounds, ammonium carbonate, ammonium nitrite, light metals which evolve hydrogen upon reaction with water, azodicarbonamide, N,N′-dinitrosopentamethylenetetramine, and the like. Exemplary blowing agents of the evaporation type include, but are not intended to be limited to, trichloromonofluoromethane, trichlorotrifluoroethane, methylene chloride, compressed nitrogen, and the like.

Any suitable material may be used for other non-SMP coupling components, portions of components and their features disclosed herein and discussed further below. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends.

As used herein, the term vehicle is not limited to just an automobile, truck, van or sport utility vehicle, but includes any self-propelled or towed conveyance suitable for transporting a burden.

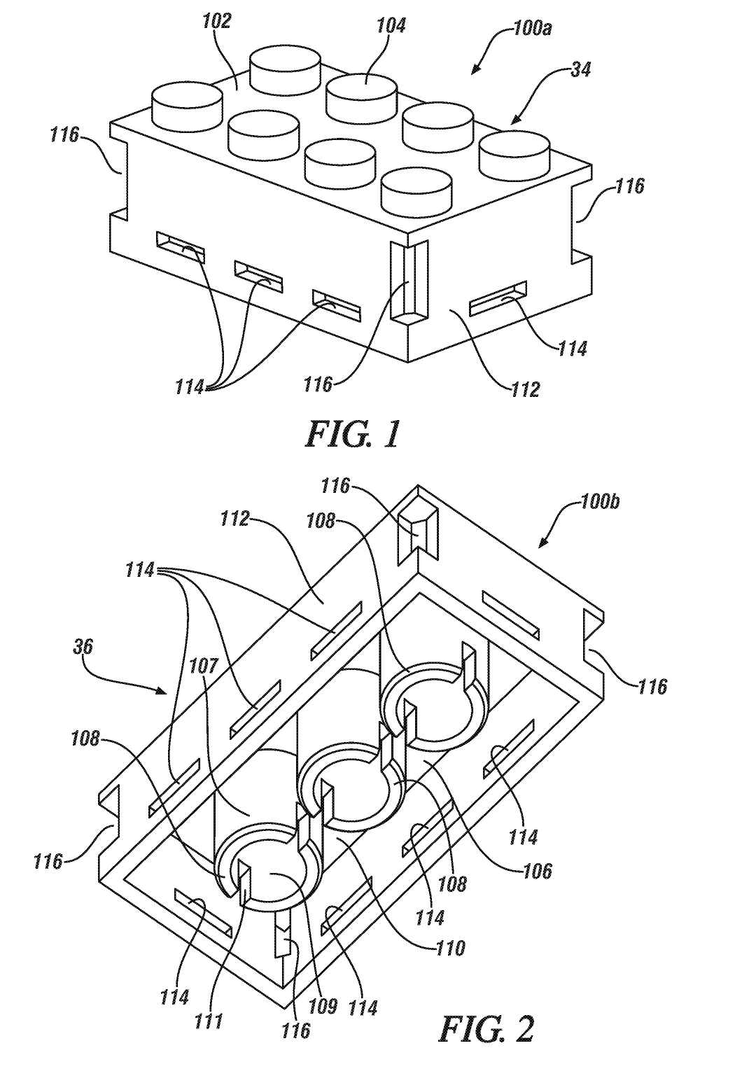

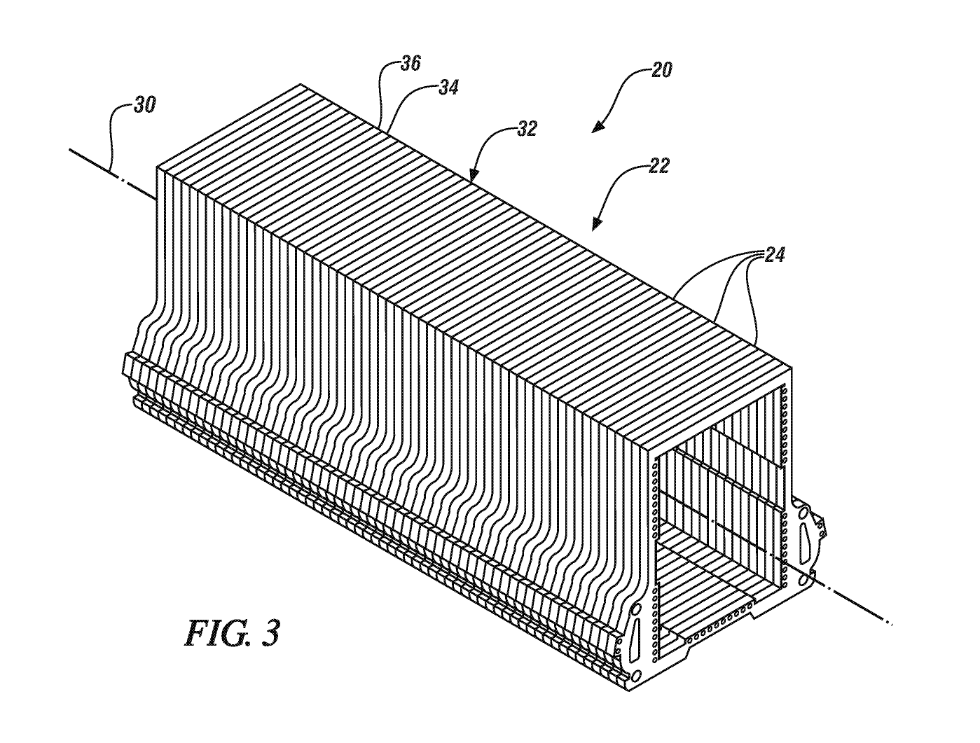

Referring now to the Figures, wherein like numerals indicate like parts throughout the several views, FIGS. 1 and 2 depict a first and second component, respectively, although in some embodiments as described in more detail below, FIGS. 1 and 2 can represent top and bottom views of two identical components that serve as the ‘first’ and ‘second’ components described herein. For ease of illustration, FIGS. 1 and 2 depict the first and second components as simple block structures. However, in practice many different configurations can be utilized depending on the end use application. For example, an example of a configuration useful as a frame for an energy storage or generation device such as a battery pack or fuel cell is schematically depicted in FIGS. 3-5.

As shown in FIGS. 3-5, an assembly 20 includes an energy storage or generation device 22, such as but not limited to a battery pack or a fuel cell pack. However, the assembly 20 may include some other vehicular assembly 20 not shown or described herein, including but not limited to a dashboard assembly 20 or a body panel assembly 20. Although the invention disclosed herein is described incorporated into the energy storage or generation device 22, it should be appreciated that the invention may be incorporated into other vehicular assemblies 20, and that the energy storage or generation device 22 is simply described as an exemplary embodiment of a vehicular assembly 20 including the invention.

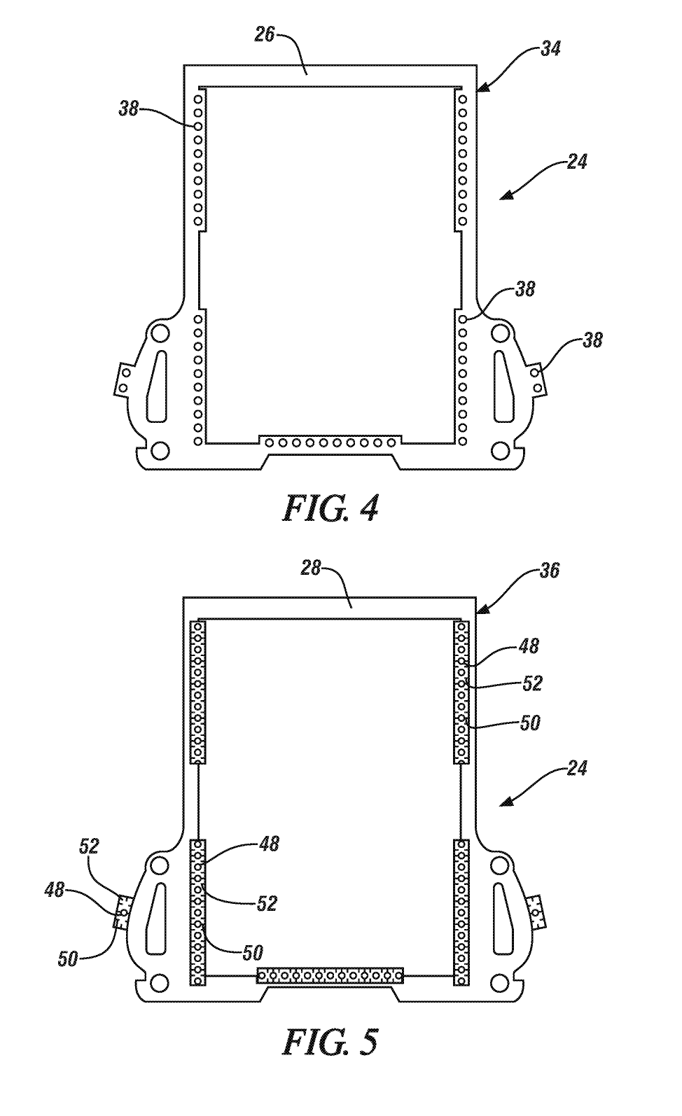

With continued reference to FIGS. 3-5, the energy storage or generation device 22 includes a plurality of generally planar members 24. Each of the members includes a first face 26, shown in FIG. 4, and a second face 28, shown in FIG. 5. The first face 26 and the second face 28 of the plurality of planar members 24 are defined by opposing, i.e., opposite, surfaces of each of the planar members 24. The plurality of planar members 24 are arranged face-to-face adjacent each other along a longitudinal axis 30 to define a continuous stack 32 of planar members 24. Accordingly, each first face 26 of one of the planar members 24 is disposed adjacent a second face 28 of another of the planar members 24. The stack 32 of planar members 24 may include any number of planar members 24. For example, the energy storage or generation device 22 may include several hundred of the planar members 24. It should be appreciated that the exposed face of the end members of the stack 32 are not disposed adjacent other planar members 24. The first face 26 includes a number of circular engaging protrusions 38. The second face 28 includes a number of circular receiving protrusions 48 and associated linear receiving protrusions 50, as well linear receiving protrusions 52. When the planar members are coupled together, the engaging protrusions will be disposed in spaces between the circular receiving protrusions 48 and the linear receiving protrusions 52. It should be noted that the terms “engaging” and “receiving” are arbitrary terms meant solely to distinguish between two sets of protrusions and do not have any independent meaning as used herein. In some embodiments, the engaging protrusions can be relatively non-deformable and can primarily serve a function of locating the planar members as they are interposed between the receiving protrusions, while the receiving protrusions accommodate some degree of compression to provide an elastically-averaged retention force that helps maintain the planar members in a coupled configuration. However, the invention is not limited to such assigned functions, and in some embodiments, the receiving protrusions can be relatively non-deformable to primarily serve a locating function while the engaging protrusions accommodate compression, or both the engaging and receiving protrusions can accommodate some degree of compression and/or can both provide locating and retention force functions.

For the purpose of describing the invention, the plurality of planar members 24 is described herein in terms of a first member 34 (e.g., FIG. 1), and a second member 36 (e.g., FIG. 2). However, it should be appreciated that the stack 32 of planar members 24 may include, but is not required to include, more than the first member 34 and the second member 36, and that the description of the first member 34 and the second member 36 is applicable to all of the plurality of planar members 24.

Turning now to FIGS. 1-2 and 6-8, a first component 100a (34) is schematically depicted in FIG. 1 and a second component 100b (36) is schematically depicted in FIG. 2. Although it is not required, the first and second components can be identical or similarly configured with two mating faces so that multiple components can be serially assembled in a stack configuration as described above with respect to FIGS. 3-5. Accordingly, the first and second components depicted in FIGS. 1-2 may be referred to below as simply “the component”. It should be noted here that although it is contemplated that multiple components in a stack can have SMP features to provide the retention force characteristics described herein throughout the stack, with respect to any two components the retention force characteristics can be achieved with only of the components having the SMP protrusions or features. The other component does not need to be made in whole or in part of an SMP material. In some stack configuration embodiments, every other component in the stack is fitted with SMP protrusions or features. In some stack configuration embodiments, every component in the stack is fitted with SMP protrusions or features.

As shown in FIG. 1, the component has a mating side 102 with engaging protrusions 104 disposed thereon. As shown in FIG. 2, the component has a mating side 106 with receiving protrusions 108 disposed thereon. In some embodiments, the receiving protrusions 108 can include a protrusion wall 107 surrounding a hollow space 109. In some embodiments, the protrusion wall 107 can include a special feature like a notched opening 111 that can trigger and/or control the deformation mode of the protrusion wall 107. The receiving protrusions 108 are disposed in an open cavity 110 surrounded by a wall 112. In some embodiments, the wall 112, along with the engaging protrusions 104 and receiving protrusions 108, can be configured such that when two or more components are assembled together, the walls 112 of the components cooperate to form a contiguous wall structure similar to that depicted in FIG. 3. In some embodiments, the wall 112 can include design features such as airflow openings 114 or cut-outs 116 that can trigger and/or control the deformation mode of the component. Although the invention is not limited by any particular property or theory of operation, in some embodiments the airflow openings 114 can assist with thermal management during heating of assembled components by allowing air to flow in or out of the cavity 110 of the assembled components. In some embodiments, the cut-outs 116 can assist with absorbing thermally-imposed stress/strain by triggering and/or controlling the deformation of the component that may occur during heating, assembly, disassembly or cooling of the assembled components.

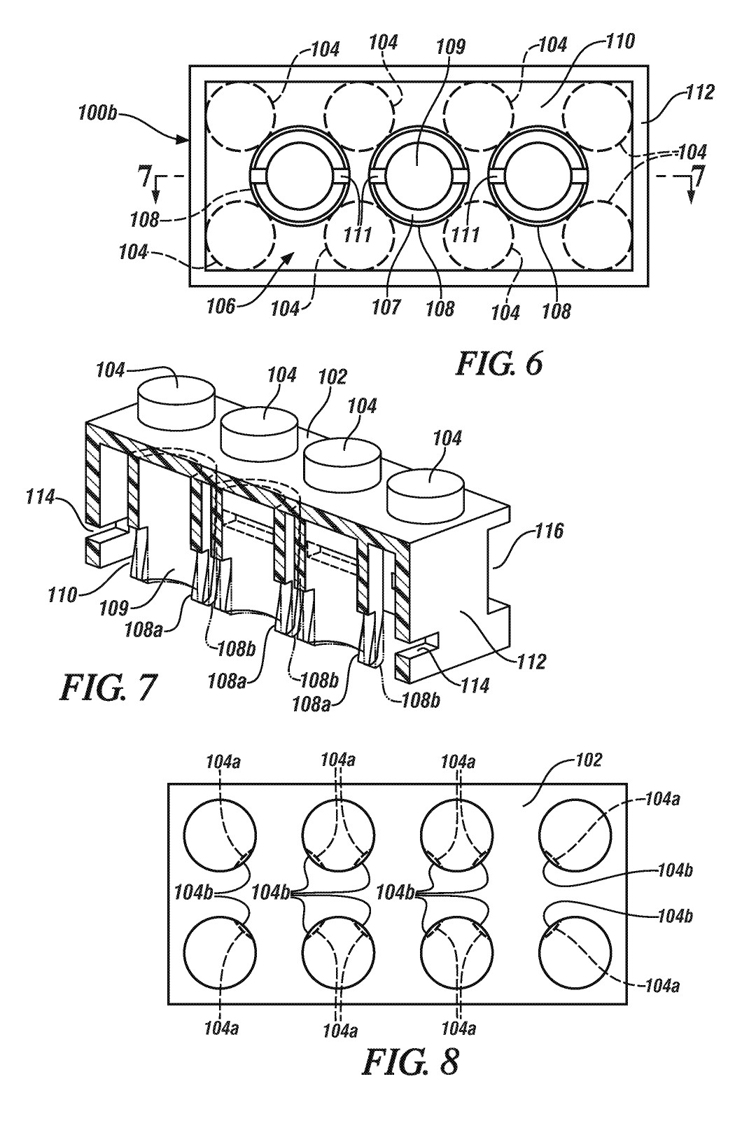

FIG. 6 is a schematic depiction of the component side 106 in an assembled state, showing the respective positions of the engaging protrusions 104 and the receiving protrusions 108. In some embodiments, the protrusions 104, 108 and optionally the wall 112 are engaged in a press fit with elastic averaging to provide a retention force. As used herein, “retention force” means the minimum amount of force in a direction normal to the mating sides 102, 106 required to separate the assembled components from an assembled state. As disclosed above, varying levels of retention force are provided by different shape configurations of the SMP receiving protrusions 108. An example embodiment of different shape configurations of the SMP receiving protrusions 108 is schematically depicted in FIG. 7, which is a perspective view of the component, which is for ease of illustration taken along a cross-section parting line 7 shown in FIG. 6. As shown in FIG. 7, in some embodiments the receiving protrusions can have a temporary shape configuration 108a and a permanent shape configuration 108b. The permanent shape configurations can be programmed into the receiving protrusions by forming the receiving protrusions in the permanent shape configuration at a temperature above a transition temperature, which can be a molding temperature at which a semi-crystalline SMP is in a flowable state for molding or the highest glass transition temperature for an amorphous SMP. The temporary shape configuration 108a can be programmed by heating the receiving protrusions 108 to a transition temperature at which the SMP softens into a deformable state (e.g., a glass transition temperature (T_{g}) for an amorphous SMP or a melting transition temperature (Tₘ) for a semi-crystalline SMP), deforming the protrusions to the temporary shape configuration 108b, and cooling the protrusions to a temperature below the transition temperature. At the temporary shape configuration 108a, the receiving protrusion wall 107 is deformed toward the center of the hollow space 109. This provides a relatively lower level of retention force between the components compared to the permanent shape configuration 108b, and the components can be readily assembled together at this lower level of retention force. After assembly, the receiving protrusions 108, optionally including any other portions or the entire assembled structure, can be heated at or above a transition temperature (e.g., the temperature at which the temporary shape was programmed), and the temperature optionally maintained for a period of time to recover the permanent shape configuration 108b, providing a second level of retention force for final assembly that is higher than the first retention force level.

Of course, the above embodiments are representative examples, and many variations can be employed according to this disclosure. For example, different shapes or configurations can be utilized depending on the end use application. Also, the use of different shape configurations to provide different levels of retention force for during the assembly process and for final assembly is not limited to a single set of protrusions, identified herein as “receiving” protrusions. For example, the engaging protrusions can also be fabricated from a shape memory polymer and can have different shape configurations to provide different levels of retention force. An example of such an embodiment is shown in FIG. 8, where engaging protrusions 104 have a temporary shape configuration 104a that can be employed during assembly, and a permanent shape configuration 104b that can be employed for final assembly after the components have been assembled together. At the temporary shape configuration 104a, portions of the exterior of the engaging protrusions 104 are deformed toward the center of the protrusions. This provides a relatively lower level of retention force between the components compared to the permanent shape configuration 104b, and the components can be readily assembled together at this lower level of retention force. Bearing in mind that the terms “receiving” and “engaging” are arbitrary terms, and that either of the protrusions 104 or 108 can be designated as “receiving” or “engaging”, it follows that either or both of the protrusions 104 or 108 can be fabricated from a shape memory polymer and either or both of the protrusions 104 or 108 can utilize different shape configurations to provide different levels of retention force for during assembly or for final assembly.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation of material to the teachings of the invention without departing from the essential scope thereof. Therefore, it is intended that the invention not be limited to the particular embodiments disclosed, but that the invention will include all embodiments falling within the scope of the application.

What is claimed is:

1. A method of manufacturing an assembly, the assembly comprising:
a first component comprising a plurality of engaging protrusions; and
a second component comprising a plurality of receiving protrusions that comprise a shape memory polymer in a first shape configuration; the method comprising:
assembling the first and second components, engaging the engaging protrusions with the receiving protrusions at a first level of retention force between the engaging protrusions and the receiving protrusions; and
heating the receiving protrusions above the transition temperature to recover a second shape configuration, and cooling the receiving protrusions below the transition temperature to retain the second shape configuration and provide a second level of retention force between the engaging protrusions and the receiving protrusions.

2. The method of claim 1, wherein the second component comprises an open cavity surrounded by a wall, and the receiving protrusions are disposed in the open cavity.

3. The method of claim 2, wherein the wall comprises one or more airflow openings from extending from an outer wall surface to the open cavity.

4. The method of claim 2, wherein the wall comprises one or more cut-outs.

5. The method of claim 1, wherein the first and second components each comprise a receiving surface comprising receiving protrusions disposed in an open cavity and an engaging surface comprising engaging protrusions, and the first and second components are assembled in a stack configuration with additional components wherein the respective walls of the first component, second component, and additional components cooperate to form a contiguous wall structure.

6. The method of claim 1, wherein the first and second components each comprise an engaging surface comprising engaging protrusions and a receiving surface comprising receiving protrusions, and the first and second components are assembled in a stack configuration.

7. The method of claim 6, comprising assembling the stack, and simultaneously heating the receiving protrusions in the stack above the transition temperature to recover the second shape configuration.

8. The method of claim 6, comprising sequentially heating selected receiving protrusions in the stack above the transition temperature to recover the second shape configuration.

9. The method of claim 1, further comprising heating the receiving protrusions of the assembled first and second components above the transition temperature, and disassembling the first and second components.

10. The method of claim 9, wherein protrusion wall comprises a notched opening.

11. The method of claim 1, wherein the first component protrusions comprise a shape memory polymer in a first shape configuration, and the method comprises:
after assembling the first and second components, heating the first component shape memory polymer protrusions above the transition temperature to recover a first component second shape configuration and provide a second level of retention force between the first component protrusions and second component protrusions.

12. The method of claim 1, wherein the second level of retention force is greater than the first level of retention force.

13. The method of claim 1, wherein the first level of retention force is greater than the second level of retention force.

14. A coupling system comprising:
a first component comprising a plurality of engaging protrusions; and
a second component comprising a plurality of receiving protrusions configured for engagement with the first component engaging protrusions, the receiving protrusions comprising a shape memory polymer configured in a first shape configuration, with a second recoverable stored shape configuration; wherein
the engaging protrusions and receiving protrusions are configured to engage at a first level of retention force with the receiving protrusions configured in the first shape configuration, and at a second level of retention force with the receiving protrusions configured in the second shape configuration.

15. The coupling system of claim 14, wherein the second component comprises an open cavity surrounded by a wall, and the receiving protrusions are disposed in the open cavity.

16. The coupling system of claim 15, wherein the wall comprises one or more airflow openings from extending from an outer wall surface to the open cavity.

17. The coupling system of claim 15, wherein the wall comprises one or more cut-outs that accommodate deformation of the wall during assembly of the first and second components.

18. The coupling system of claim 15, wherein the first and second components each comprise a receiving surface comprising receiving protrusions disposed in an open cavity and an engaging surface comprising engaging protrusions, and the first and second components are assembled in a stack configuration with additional components wherein the respective walls of the first component, second component, and additional components cooperate to form a contiguous wall structure.

19. The coupling system of claim 14, wherein the first and second components each comprise an engaging surface comprising engaging protrusions and a receiving surface comprising receiving protrusions, and the first and second components are assembled in a stack configuration with additional components.

20. The coupling system of claim 19, wherein protrusion wall comprises a notched opening.
